(19) United States
(12) Patent Application Publication
(10) Pub. No.: US 2010/0177617 A1
(43) Pub. Date: Jul. 15, 2010

(54) METHOD AND DEVICE FOR REDUCING A PERCEIVED DISCONTINUITY IN A CONTINUOUS DIGITAL INFORMATION STREAM

(75) Inventor: Ronald Joseph Antonius Van Den Oetelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/160,798

(22) PCT Filed: Jan. 8, 2007
(86) PCT No.: PCT/IB2007/050053

§ 371 Date: Jul. 14, 2008

(30) Foreign Application Priority Data
Jan. 13, 2006 (EP) 06100329.9

(51) Int. Cl. G11B 7/20

(52) U.S. Cl. 369/94; G9B/7.137

(57) ABSTRACT

A method and a device are disclosed for reducing a perceived discontinuity in a continuous digital information stream read back from a first (LO) and a second (L1) layer of a multi-layer record carrier (104), said discontinuity occurring during the transition from the first (LO) to the second (L1) layer. The method comprises the steps of monitoring (S1) said digital information stream to be recorded on said multi-layer record carrier (104), determining (S2) a time (ti) corresponding to a point in said digital information stream where an effect of a perceived discontinuity is reduced, and recording (S3) said digital information stream such that a transition from recording on the first layer (LO) to recording on the second layer (L1) of the multi-layer record carrier (104) occurs at said determined time (ti), thereby reducing perceived discontinuity that occurs in, for example, a read back device with a relatively small data buffer. Furthermore, it provides for the possibilities to reduce the data buffer size and relax the time constraints on the active components used during read back in a device arranged for read back of a multi-layer record carrier.

The present invention relates to a method for recording a digital information stream on a first and a second layer of a multi-layer record carrier such that a perceived discontinuity when reading the digital information stream from the multi-layer record carrier is reduced. The present invention also relates to a device arranged to perform such a method.

Digital Versatile Disc, DVD, is the new generation of optical disc storage technology. DVD is essentially a bigger and faster CD that can hold cinema-like video, better-than-CD-quality audio, still photos, and computer data. DVD aims to encompass home entertainment, computers, and business information with a single digital format. It has replaced laserdisc, is well on the way to replacing videotape and video game cartridges, and could eventually replace audio CD and CD-ROM. In order to further enhance the data capacity of such an optical storage medium, the number of information layers that can be accessed from one side of the medium may be increased, thus creating a multi-layer record carrier. A clear advantage of a dual-layer disc, compared to a double-sided disc, is that both information layers can be accessed from the same side of the disc, whereas a double-sided disc requires the user to flip over the disc in order to access the other information layer.

During read back of a multi-layer record carrier, such as a dual-layer disc, in a device adapted for reading such a multi-layer record carrier, the transition from one information layer to another layer will require some time. In the case where the digital information to be recorded on the multi-layer record carrier is for example digital video and/or audio, and the video and/or audio consists of shorter episodes, chapters, songs or the like, it is possible to place the point of transition from a first layer to a second layer of the multi-layer record carrier in between these shorter episodes, chapters, and songs.

However, if the digital video and/or audio information is in the form of a continuous digital information stream, such as a movie, a rather long piece of music, or a continuous recording of streaming video and/or audio information, the time it takes to transcend from the first layer to the second layer may result in a freeze in the video and/or audio during read back, thereby affecting the viewing and/or listening experience perceived by the user.

A solution to this problem is to introduce a sufficiently large data buffer in the read back device, and thereby provide a freeze-free read back. However, because of cost reduction, many read back devices, such as off the shelf DVD players and already installed DVD players (legacy drives), tend to have only a small buffer size.

It is therefore an object of the present invention to provide an improved method and device for recording a digital information stream on a first and a second layer of a multi-layer record carrier such that a perceived discontinuity when reading the recorded continuous digital information stream from the multi-layer record carrier is reduced, thereby reducing the need for a large data buffer, which substantially overcomes the disadvantages of the prior art.

The above object is achieved by providing a method for recording a digital information stream on a first and a second layer of a multi-layer record carrier, the method comprising the steps of monitoring said digital information stream to be recorded on said multi-layer record carrier, determining a time corresponding to a point in said digital information stream where an effect of a perceived discontinuity is reduced, and recording said digital information stream such that a transition from recording on the first layer to recording on the second layer of the multi-layer record carrier occurs at said determined time. The appended claims 2 to 7 define advantageous embodiments in accordance with the present invention.

By selecting the transition time between a first and a second layer in accordance with the present invention, it is in a more efficient way possible to minimize the perceived discontinuity that occurs during read back in, for example, a read back device having a relatively small data buffer. The electronic and mechanical parts (for example, drive and controller components) in such a read back device tend to have high timing constraints, for example to be able to transcend between layers quickly enough. The present invention provides for the possibilities to relax these time constraints, as the layer jump is positioned in such a way that the perceived discontinuity is minimized.

In one embodiment of the present invention, the continuous digital information stream comprises at least one of digital audio and digital video information, and the step of determining is performed by determining when at least one of an audio bit rate and a video bit rate in the digital information stream falls below a predetermined threshold. Typically, the bit rate of the video and audio accounts for the amount of motion in a video frame, and/or the amount (frequencies and amplitude) of sound, respectively. By monitoring if and when the bit rate falls below the predetermined threshold, and determining the time for the transition based on when the bit rate falls below the threshold, the perceived discontinuity occurring during read back can be minimized. A temporary freeze of video or audio at a minimum bit rate will be significantly less noticeable or disturbing to the user than a freeze at high bit rates, corresponding to a lot of motion and/or sound.

In a further embodiment of the present invention the step of determining is performed by determining when an intensity content in the digital information stream falls below a predetermined threshold. A large amount of dark colors (for example, a large amount of low RGB color code numbers in the continuous digital information stream) can obscure movements. Determining the time for the transition in such an image will strongly mask a temporary video freeze.

In a further embodiment of the present invention the predetermined threshold is a weighted combination of the bit rate and intensity for the audio and video. This allows for several properties of the digital information stream to be taken into account when the time for the transition is determined. Furthermore, a preference when selecting the criterions for the threshold may be specified, for example by the user of the device when recording the multi-layer record carrier. A low audio bit rate may, for example, be the most important criterion while recording a music concert.

Preferably, the threshold is time-variable. For example, in the case where continuous streaming video and/or audio information is to be recorded on the multi-layer record carrier, it is possible to raise the threshold as the continuous recording of information approaches the maximum amount of information that is possible to store on the first layer of the multi-layer record carrier. If, however, the bit rate and/or intensity still have not fallen below the threshold when the first layer of the multi-layer record carrier is full (that is, the maximum amount of information has been recorded), the time for the transition will be determined at this point.

The predetermined threshold may furthermore be set in accordance with the type of continuous digital information stream to be recorded. For example, in the case where the continuous digital information stream comprises normal video and a more complex audio content, such as audio information having a high frequency distribution, the threshold is preferably set such that more consideration is taken to the audio content. Furthermore, the predetermined threshold may be pre-set in a factory, or set by a user by means of a user interface.

The method according to the present invention is preferably used when recording a digital versatile disc, DVD. However, it should be understood that the present invention could generally be used when recording information on any type of recordable and/or rewritable multi-layer optical storage medium, such as a Blu-ray Disc (BD) or a HD-DVD. At present, 4-layer (quadruple-layer) and 8-layer BD media are being considered.

According to another aspect of the present invention the above object is further achieved by providing a device for recording a digital information stream on a multi-layer record carrier, the device comprising means for monitoring said digital information stream to be recorded on said multi-layer record carrier, means for determining a time corresponding to a point in said digital information stream where an effect of a perceived discontinuity is reduced, and means for recording said digital information stream such that a transition from recording on a first layer to recording on a second layer of the multi-layer record carrier occurs at said determined time. The appended claims 9 to 12 define advantageous embodiments in accordance with the present invention.

As discussed above in relation to the first aspect of the present invention, it is possible to reduce the data buffer size, and relax the time constraints on the active components used during read back in a such a device, thereby providing a reduction of cost and complexity when the device is designed and manufactured. Furthermore, this aspect of the invention provides similar and analogous advantages as described above with reference to the first aspect of the invention.

The expression “a continuous digital information stream” is understood to mean in the context of this application a digital information stream such as a movie, a rather long piece of music, or a continuous recording of streaming video and/or audio information. As understood by the skilled addressee, the “means” according to the present invention can for example be implemented in a control unit, such as a suitably programmed microprocessor, and/or by means of hardware comprising several distinct elements. In the claims enumerating several “means”, several of these “means” may be embodied by one and the same item of hardware

Further features of and advantages with the present invention will become apparent when studying the appended claims and the following description. Those skilled in the art realize that different features of the present invention can be combined to create embodiments other than those described in the following.

These and other aspects of the present invention will now be described in more detail with reference to the appended drawings showing currently preferred embodiments of the invention, in which

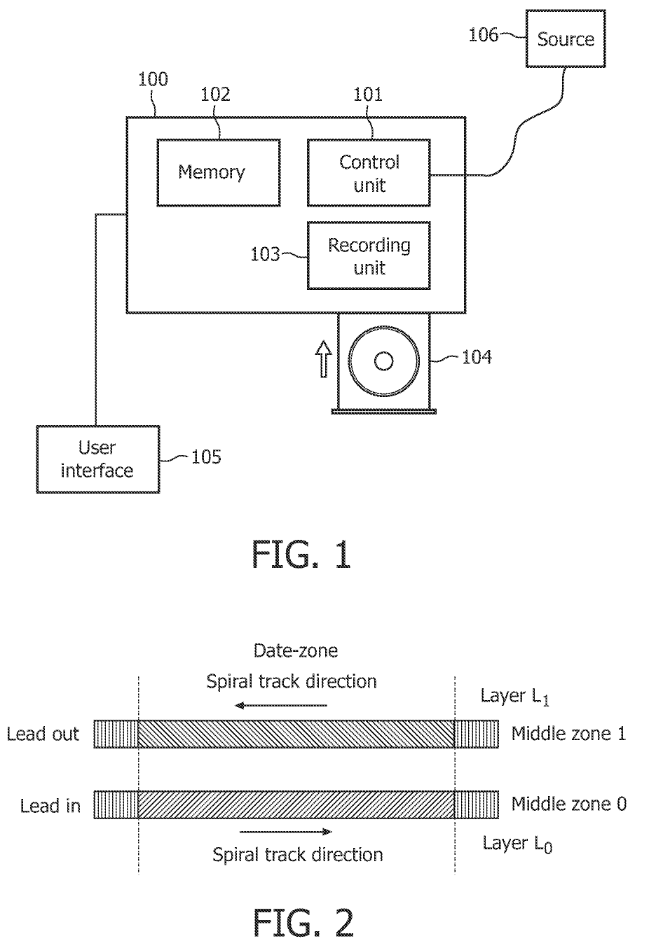

FIG. 1 shows a device for recording a digital information stream on a multi-layer record carrier in accordance with the present invention;

FIG. 2 illustrates a dual-layer record carrier;

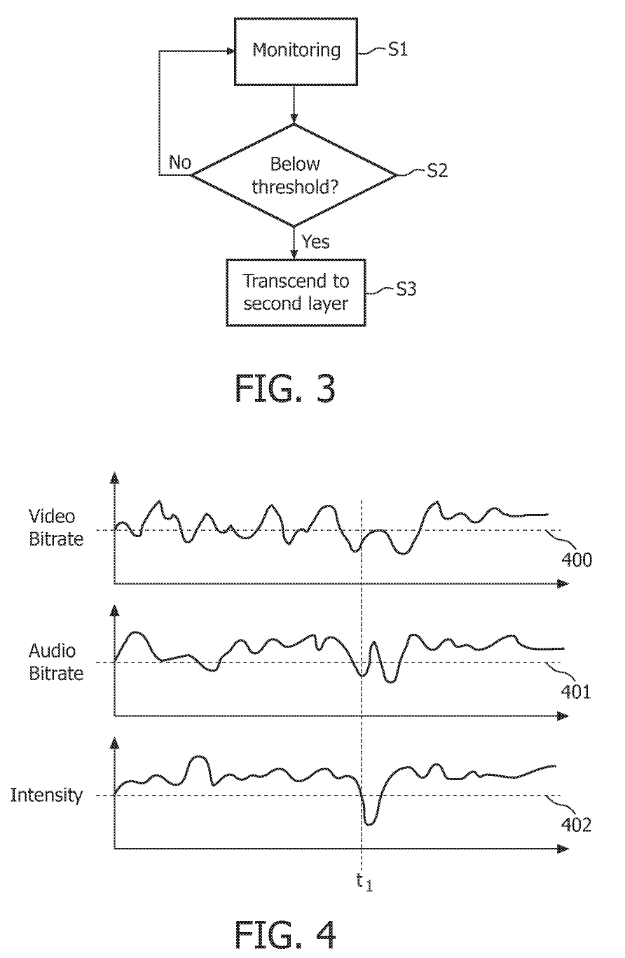

FIG. 3 is a flow chart showing the steps of the present invention;

FIG. 4 shows three graphs in which, in accordance with the present invention, predetermined thresholds are compared to a video bit rate, an audio bit rate, and an intensity, respectively.

FIG. 1 shows a device 100 according to a preferred embodiment of the present invention for recording a digital information stream on a multi-layer record carrier 104, such as a dual-layer DVD+R. In the exemplary embodiment, a source 106 generates a continuous stream of digital information, such as digital video and/or digital audio data. The source 106 may, for example, comprise at least a camcorder, a microphone or a hard drive where the digital information has been stored. The skilled addressee readily understands that other types of sources 106 might be used. The device 100 further comprises a recording unit 103, for example a laser unit for writing data on the DVD. A control unit 101 and a memory 102 control this recording unit 103. A user interface 105 may optionally be included for control and adjustment of the device 100. As understood by the skilled addressee, the device according to the present invention might be implemented together with the source 106, such as, for example, a camcorder having an integrated device for recording digital information content on a multi-layer record carrier 104.

The control unit 101 may include a microprocessor, microcontroller, programmable digital signal processor, or another programmable device. The control unit 101 may also, or instead, include an application-specific integrated circuit, a programmable gate array, programmable array logic, a programmable logic device, or a digital signal processor. Where the control unit 101 includes a programmable device, such as the microprocessor or microcontroller mentioned above, the processor may further include a computer executable code that controls operation of the programmable device. The functionality of the control unit 101 will be described in more detail below.

According to the dual-layer DVD standards two different formats are defined: Opposite Track Path, OTP, discs and Parallel Track Path, PTP, discs. FIG. 2 illustrates a fully written OTP type dual-layer DVD+R disc, having a first layer L0 and a second layer L1, with the full amount of 8.5 GByte of data recorded on the disc. The spiral track direction of layer L0 is from inside to outside (that is, from Lead in to Middle zone 0), and the spiral track direction of layer L1 is from outside to inside (that is, from Middle zone 1 to Lead out). The Lead in, Lead out and Middle zone sections are used for storing information of what kind of data that is stored on the layer, if the DVD is finalized, and so on. If a time for transition from the first layer L0 to the second layer L1 is selected in accordance with the present invention, a perceived discontinuity that occurs when, for example, a DVD reader is transcending from the first layer L0 to the second layer L1 will be reduced.

The method steps of a preferred embodiment of the present invention are illustrated in FIG. 3. These steps are explained by way of an example in which the dual-layer DVD has the ability to store one hour of high quality (HQ) audio and video data on each of the layers L0 and L1. In this example, the continuous digital information stream to be recorded comprises a mixture of audio and video data, having a length of one hour and forty minutes. Hence, it is possible to position the transition from the first layer L0 to the second layer L1 somewhere between 40 and 60 minutes in the digital information stream to be recorded, and still fit all of information on one dual-layer DVD.

To reduce a perceived discontinuity (that is, a freeze in the video and/or audio) during read back of the dual-layer DVD that will take place when the read back device, such as a DVD player, transcends from the first layer L0 to the second layer L1, it is necessary to determine a time t₁ at which the transition can take place such that the user viewing/listening to the recorded continuous digital information stream is not significantly disturbed by the freeze in the video and/or audio. The data stream is received by the control unit 101 and further supplied to the recording unit 103.

As the continuous digital information stream in the exemplary embodiment is provided by a real-time source 106, in this case a camcorder, the recording means 103 will immediately start to record the information stream on the first layer L0. After a predefined time of recording, for example 40 minutes, the control unit 101 will in step S1 start to monitor the information stream, and calculate the audio bit rate, video bit rate and the intensity for a frame of video. In accordance with the present invention a video frame is defined as an image frame and the audio corresponding to that image frame. In the case where the video is black and white, the intensity in an image frame is calculated by measuring the amount of dark colors in the image, where the image in this case will consist of only one channel. If, however, the video is in color, all three different channels (red, green and blue; RGB) have to be measured. As is known by the skilled addressee, the video might be encoded in various different formats (such as Y/Cr/Cb), and the intensity will in that case be calculated correspondingly.

In step S2, the control unit 101 will compare the bit rates and the intensity for that image frame with predetermined thresholds. The predetermined thresholds may be pre-programmed in the memory 102 during manufacturing, or can be programmed by the user by means of the user interface 105. In FIG. 4, the comparison between the bit rates and intensity and predetermined thresholds 400, 401 and 402 can be seen. The thresholds 400, 401 and 402 correspond to the video bit rate, audio bit rate and the intensity, respectively. If the bit rates and the intensity for that image frame do not fall below the predetermined thresholds, the step S1 of monitoring will once again be executed. If, on the other hand, both the bit rates and the intensity for that image frame fall below the thresholds 400, 401 and 402, such as at time t₁ in FIG. 4, the process will proceed to step S3 where the recording means 103 will immediately be arranged to record the remainder of the information stream on the second layer L1. However, if the end of layer L0 is reached, and both the bit rates and the intensity for that image frame still not have fallen below the thresholds 400, 401 and 402, the recording means 103 will be arranged to record the remainder of the information stream on the second layer L1. As understood by the skilled addressee, it is possible to compare one or two of the bit rates and the intensity with the predetermined thresholds.

Alternatively, the predetermined threshold might be relaxed (that is, the threshold value is increased) as the recording reaches the end of the first layer L0. For example the video bit rate criterion might be gradually released as the end of layer L0 is approaching. For example, if the previously determined lowest bit rate or programmed threshold value is 1.8 Mb/s, starting from for example 52 minutes, this threshold value will be increased by 17 kb/s (=1 Mb/s per minute) until this new value is observed and a transition between layers can take place.

In another example, the predetermined threshold can be determined as a function of time (t):

$$\begin{matrix}{BR}_{low} & if & {t}_{opt} \leq t < {t}_{opt} + {t}_{start} \\ {BR}_{low} + \frac{( {BR}_{max} - {BR}_{low} ) ( t - {t}_{opt} - {t}_{start} )}{{t}_{max} - {t}_{opt} - {t}_{start}} & if & t > {t}_{opt} + {t}_{start}\end{matrix}$$

in which:
BR_{low}=Previously determined lowest bit rate or predetermined threshold value

(in this example: 1.8 Mb/s)

BRₘₐₓ=Maximum bit rate of encoding standard

(DVD MPEG2 standard: 9.8 Mb/s)

tₘₐₓ=Maximum recording time on one layer

(in this example: 1 hour in HQ mode)

tₒₚₜ=Total time of video to be recorded divided by the number of layers

(in this example: 50 minutes)

tₛₜₐᵣₜ=Time after tₒₚₜ from which the bit rate criterion will be released

(in this example: 2 minutes)

It should be noted that a selection of the predetermined thresholds may be relaxed while the other predetermined thresholds remain at a fixed level. Furthermore, not all predetermined thresholds need to be relaxed at the same rate.

The skilled addressee realizes that the present invention is by no means limited to the preferred embodiments described above. On the contrary, many modifications and variations are possible within the scope of the appended claims. For example, the present invention can be extended from a dual-layer DVD+R disc to any recordable and/or rewritable multi-layer optical storage medium. Furthermore, the present invention is advantageously used in various types of recording devices; both in normal computer environments and in stand-alone devices such as portable recording devices.

1. Method for recording a digital information stream on a first (L0) and a second (L1) layer of a multi-layer record carrier (104), said method comprising the steps of:
monitoring (S1) said digital information stream to be recorded on said multi-layer record carrier (104);
determining (S2) a time (t₁) corresponding to a point in said digital information stream where an effect of a perceived discontinuity is reduced; and
recording (S3) said digital information stream such that a transition from recording on the first layer (L0) to recording on the second layer (L1) of the multi-layer record carrier (104) occurs at said determined time (t₁).

2. Method according to claim 1, wherein said digital information stream comprises at least one of digital audio and digital video information, and wherein said step of determining (S2) is performed by determining when at least one of an audio bit rate and a video bit rate in said digital information stream falls below a predetermined threshold (400, 401).

3. Method according to claim 1, wherein said digital information stream comprises at least one of digital audio and digital video information, and wherein said step of determining (S2) is performed by determining when an intensity content in said digital information stream falls below a predetermined threshold (402).

4. Method according to claim 2, wherein said predetermined threshold (400, 401, 402) is determined by a weighted combination of at least two of said audio bit rate, said video bit rate, and said intensity content in said digital information stream.

5. Method according to claim 2, wherein said predetermined threshold (400, 401, 402) is time variable.

6. Method according to claim 5, wherein the value of said time variable threshold depends on the amount of said digital information stream recorded on the first layer (L0) of the multi-layer record carrier (104).

7. Method according to claim 2, wherein said predetermined threshold (400, 401, 402) is set according to the type of information represented by the digital information stream to be recorded.

8. Device (100) for recording a digital information stream on a multi-layer record carrier (104), said device (100) comprising:
means (101) for monitoring said digital information stream to be recorded on said multi-layer record carrier (104);
means (101) for determining a time (t₁) corresponding to a point in said digital information stream where an effect of a perceived discontinuity is reduced; and
means (103) for recording said digital information stream such that a transition from recording on a first layer (L0) to recording on a second layer (L1) of the multi-layer record carrier (104) occurs at said determined time (t₁).

9. Device (100) according to claim 8, wherein said digital information stream comprises at least one of digital audio and digital video information, and wherein said means (101) for determining is arranged for comparing at least an audio bit rate, or a video bit rate or an intensity content in said digital information stream with a threshold (400, 401, 402).

10. Device (100) according to claim 9, wherein said means (101) for determining is arranged for comparing said at least an audio bit rate, or a video bit rate or an intensity content in said digital information stream with a time-variable threshold.

11. Device (100) according to claim 10, wherein said means (101) for determining is arranged for setting the value of said time-variable threshold depending on the amount of said digital information stream recorded on the first layer (L0) of the multi-layer record carrier (104).

12. Device (100) according to claim 9, further comprising means (105) for having the threshold set by a user.
